(19) United States
(12) Patent Application Publication
(10) Pub. No.: US 2014/0342892 A1
(43) Pub. Date: Nov. 20, 2014

(54) SEMICONDUCTIVE ROLLER

(71) Applicant: SUMITOMO RUBBER INDUSTRIES, LTD., Hyogo (JP)

(72) Inventor: KEI TAJIMA, HYOGO (JP)

(73) Assignee: SUMITOMO RUBBER INDUSTRIES, LTD., Hyogo (JP)

(21) Appl. No.: 14/263,994

(22) Filed: Apr. 28, 2014

(30) Foreign Application Priority Data
May 17, 2013 (JP) 2013-105287

(51) Int. Cl. B05C 1/08; G03G 15/02

(52) U.S. Cl. CPC G03G 15/0233
USPC 492/18; 399/176

(57) ABSTRACT

A semiconductive roller having good semiconductivity as a charging roller or a developing roller is described. The semiconductive roller includes an oxide film having excellent characteristics as a protective film, and in particular, hardly causes an image defect of white stripes associated with tackiness in an image formed in a storage test in an environment of high temperature and high humidity. The semiconductive roller includes a semiconductive rubber composition formed by mixing a base polymer with a triazine crosslinker and a sulfur-based crosslinking component as a crosslinking component for crosslinking the base polymer, wherein the base polymer is a mixture of an epichlorohydrin rubber E and a diene rubber D having a mass ratio of E/D of 50/50 to 80/20. The semiconductive roller also has an oxide film formed on its outer peripheral surface by ultraviolet irradiation.

### CROSS-REFERENCE TO RELATED APPLICATION

This application claims priority benefit of Japan Application serial no. 2013-105287, filed on May 17, 2013. The entirety of the above-mentioned patent application is hereby incorporated by reference herein and made a part of this specification.

### BACKGROUND OF THE INVENTION

1. Field of the Invention

The invention relates to a semiconductive roller which may be used as a charging roller, a developing roller or the like in an image forming apparatus utilizing xerography, such as a laser printer, an electrostatic photocopier, a plain paper facsimile apparatus, or a multifunction machine of these apparatuses.

2. Description of the Related Art

In an image forming apparatus, a semiconductive roller may be used as a charging roller for uniformly charging a surface of a photoreceptor, or as a developing roller for developing an electrostatic latent image formed by exposing a charged surface into a toner image. The semiconductive roller is made by, for example, molding a semiconductive rubber composition into a tubular shape while crosslinking it, covering the outer peripheral surface with a coating film made of urethane resin or the like, and inserting a shaft made of metal or the like into a central through hole (see Patent Document 1, etc., for example).

Generally, the semiconductive rubber composition is prepared by imparting ionic conductivity to an ionic conductive rubber as a base polymer. Epichlorohydrin rubber or the like, for example, is known as an ionic conductive rubber.

In addition, there are also cases where a diene rubber is used in combination with the ionic conductive rubber as the base polymer, in order to improve the mechanical strength, durability, etc. of the semiconductive roller, or to improve characteristics of the semiconductive roller as a rubber, namely softness and also a characteristic of reducing permanent compression set and hardly causing a fatigue, etc.

A reason to coat the outer peripheral surface of the semiconductive roller with the coating film is that when the semiconductive roller is used as a charging roller or a developing roller in direct contact with a photoreceptor, the photoreceptor is prevented from being contaminated by components bleeding from the semiconductive rubber composition to the outer peripheral surface and thus from affecting the formed image. In addition, another reason is that an additive such as silica or the like added to a toner for improving the fluidity and the charging property of the toner is prevented from accumulating on the outer peripheral surface of the semiconductive roller and thus from affecting the formed image.

However, the coating film is formed by coating a liquid coating agent as a basis on the outer peripheral surface of the semiconductive roller by a coating method such as a spray method, a dipping method, etc. and then drying the same. In such formation process, there is a problem that various defects easily occur, such as mixing-in of foreign substances such as dust or the like, occurrence of uneven thickness, and so on.

Moreover, since the formation of such coating film is an established technique and there is little room for further improvement, it is difficult to significantly reduce the occurrence proportion of these defects (fraction defective) from the status quo. This reduces the yield and the productivity of the semiconductive roller and has become a cause of an increase in production cost.

Accordingly, the following is proposed. After the semiconductive roller is formed by the semiconductive rubber composition that combines the diene rubber as the base polymer, by performing ultraviolet irradiation on the outer peripheral surface to oxidize the diene rubber, an oxide film in place of the coating film is formed on the outer peripheral surface (see Patent Document 2, etc., for example).

Such oxide film is formed by irradiating ultraviolet rays to the outer peripheral surface of the semiconductive roller to produce an oxidation reaction on the diene rubber itself contained in the semiconductive rubber composition that forms the outer peripheral surface. Thus, in this formation step, there is no concern that the foreign substances such as dust or the like may be mixed in the oxide film. In addition, since the oxidation reaction may be performed uniformly on the outer peripheral surface of the semiconductive roller by the ultraviolet irradiation, there is either no concern that the uneven thickness may occur in the oxide film.

However, compared to the conventional coating film, the current oxide film is insufficient in the above-mentioned characteristics of a protective film.

Particularly, in an environment of high temperature and high humidity at 50° C. and a relative humidity of 90% assumed for long-term storage or transportation of the image forming apparatus, in a storage test of forming an image after 30-day standstill in which the outer peripheral surface of the semiconductive roller is in contact with the surface of the photoreceptor, there is a problem that image defects due to the contamination of the photoreceptor or the like easily occur in the formed image.

Accordingly, the following is considered. The semiconductive roller is formed by a semiconductive rubber composition using the epichlorohydrin rubber and a nitrile rubber in combination at a specified ratio as the base polymer, and a thiourea-based crosslinking component and a sulfur-based crosslinking component in combination as a crosslinking component. Accordingly, the characteristics of the oxide film formed on the outer peripheral surface of the semiconductive roller as a protective film are improved (see Patent Document 3, etc., for example).

### PRIOR-ART DOCUMENTS

### Patent Documents

Patent Document 1: Japan Patent Gazette No. 3449726

Patent Document 2: Japan Patent Application Publication No. 2004-176056

Patent Document 3: Japan Patent Application Publication No. 2011-257723

### SUMMARY OF THE INVENTION

According to the method mentioned in Patent Document 3, the characteristics of the oxide film may be improved to a certain extent.

However, as a result of a study conducted by the inventor, the following is known. In such semiconductive roller mentioned in Patent Document 3, although the oxide film is formed having excellent characteristics as a protective film, if the semiconductive roller is incorporated into, e.g., another image forming apparatus different from those mentioned in the examples of Patent Document 3, in the same environment of high temperature and high humidity at 50° C. and a relative humidity of 90% and in the storage test of forming an image after 30-day standstill in which the outer peripheral surface of the semiconductive roller is in contact with the surface of the photoreceptor, particularly under the influence of humidity, tackiness (adhesion) easily occurs. When tackiness occurs, in the area of the formed image corresponding to the portion of the photoreceptor where the tackiness is caused by the contact with the semiconductive roller, an image defect of white stripes easily occurs in which the image is turned white and into a stripe shape by a pitch of the photoreceptor.

A reason why tackiness easily occurs when the roller is incorporated into another image forming apparatus is considered to be difference in the chemical or physical properties of the photoreceptor surface in direct contact with the semiconductive roller, or difference in the diameter of the photoreceptor and the pressure contact force of the semiconductive roller to the photoreceptor, etc.

Accordingly, the invention provides a semiconductive roller having good semiconductivity as a charging roller and a developing roller. Moreover, the semiconductive roller includes an oxide film having excellent characteristics as a protective film, and in particular, hardly causes an image defect of white stripes associated with tackiness in an image formed in a storage test in an environment of high temperature and high humidity.

The invention provides a semiconductive roller including a crosslinked product of a semiconductive rubber composition and having an oxide film formed on an outer peripheral surface thereof by ultraviolet irradiation. The semiconductive rubber composition includes a base polymer and a crosslinking component for crosslinking the base polymer, wherein the base polymer is a mixture of an epichlorohydrin rubber E and a diene rubber D having a mass ratio of E/D of 50/50 to 80/20, and the crosslinking component includes a triazine crosslinker and a sulfur-based crosslinking component.

When the triazine crosslinker and the sulfur-based crosslinking component are used in combination as the crosslinking component, there is almost no change in the permanent compression set of the semiconductive roller as compared to the conventional combined use of a thiourea-based crosslinking component and sulfur-based crosslinking component. As shown from the results of later-described examples and comparative examples, the occurrence of tackiness in the storage test due to humidity is suppressed, and the image defect of white stripes associated with the tackiness can be suppressed from occurring in the formed image.

Moreover, in the invention, a reason to limit the mass ratio (E/D) between the epichlorohydrin rubber E and the diene rubber D within the aforementioned range is that in cases where the proportion of the epichlorohydrin rubber E is smaller than this range, good semiconductivity for being a charging roller or a developing roller cannot be imparted to the semiconductive roller. Another reason is that in cases where the proportion of the diene rubber D as the basis of the oxide film is smaller than the range, an oxide film sufficiently capable of functioning as a protective film cannot be formed on the outer peripheral surface of the roller, and contamination of the photoreceptor and accumulation of toner to the outer peripheral surface, etc. easily occur.

By contrast, by making the mass ratio (E/D) within the aforementioned range, the semiconductive roller is imparted with good semiconductivity while having the oxide film sufficiently capable of functioning as a protective film formed on its outer peripheral surface, so that the contamination of the photoreceptor, etc. may be surely prevented from occurring.

A mixing proportion of the triazine crosslinker is preferably within the range of 0.5 to 3.0 mass parts based on a total amount of 100 mass parts of the base polymer.

If the mixing proportion of the triazine crosslinker is less than this range, the permanent compression set of the semiconductive roller becomes larger, and during the aforementioned storage test, nip deformation may easily occur in the portion in contact with the photoreceptor. When the nip deformation occurs, in an area of the formed image corresponding to the nip deformed portion, there is still a concern that the image defect of white stripes may be easily caused by a pitch of the semiconductive roller.

On the other hand, in cases where the mixing proportion exceeds the range, the semiconductive roller becomes too hard and the follow-up property to the photoreceptor is reduced. As a result, there is a concern that shading is caused to the formed image by the pitch of the photoreceptor.

By contrast, by making the proportion of the triazine crosslinker within the above range, the semiconductive roller has a moderate degree of permanent compression set and hardness, and a good image may be formed without any image defect caused by nip deformation or any shading caused by reduction in the follow-up property.

As the sulfur-based crosslinking component, at least one crosslinker selected from the group consisting of sulfur and sulfur-containing crosslinkers, and a sulfur-containing accelerator are preferably used in combination.

In addition, the semiconductive rubber composition preferably also includes a salt (ion salt) of an anion and a cation as a conductive agent, wherein the anion has a fluoro group and a sulfonyl group in the molecule.

By including such ion salt as the conductive agent, the semiconductive roller may further be imparted with good semiconductivity.

Further, the semiconductive rubber composition preferably includes at least one additive selected from the group consisting of a crosslinking assistant, an acid acceptor, a processing aid, a filler, an antiaging agent, an antioxidant, an antiscorching agent, an ultraviolet absorber, a lubricant, a pigment, a flame retardant, a neutralizer, and an antifoaming agent.

Accordingly, when preparing the semiconductive rubber composition by mixing and kneading each component, the workability and formability in molding the semiconductive rubber composition into the shape of the semiconductive roller may be improved, the mechanical strength, durability, etc. of the semiconductive roller obtained by crosslinking the base polymer after the forming may be improved, or characteristics of the semiconductive roller as a rubber, namely softness and also a characteristic of reducing permanent compression set and hardly causing a fatigue, etc. can be improved.

The above semiconductive roller of the invention is preferably used, e.g., as a charging roller in an image forming apparatus utilizing xerography, such as a laser printer, to charge a photoreceptor in a state in contact with surface of the photoreceptor.

According to the invention, a semiconductive roller with good semiconductivity as a charging roller or a developing roller is provided. Moreover, the semiconductive roller includes an oxide film having excellent characteristics as a protective film, and in particular, hardly causes an image defect of white stripes associated with tackiness in an image formed in a storage test in an environment of high temperature and humidity.

### BRIEF DESCRIPTION OF THE DRAWINGS

FIG. 1 is a perspective view of a semiconductive roller according to an embodiment of the invention.

FIG. 2 shows a method of measuring the roller resistance of the semiconductive roller.

### DESCRIPTION OF THE EMBODIMENTS

The invention provides a semiconductive roller including a crosslinked product of a semiconductive rubber composition and having an oxide film formed on its outer peripheral surface by ultraviolet irradiation. The semiconductive rubber composition includes a base polymer and a crosslinking component for crosslinking the base polymer, wherein the base polymer is a mixture of an epichlorohydrin rubber E and a diene rubber D having a mass ratio of E/D of 50/50 to 80/20, and the crosslinking component includes a triazine crosslinker and a sulfur-based crosslinking component.

Semiconductive Rubber Composition

### <Base Polymer>

A reason to limit the mass ratio (E/D) between the epichlorohydrin rubber E and the diene rubber D as the base polymer within the range of 50/50 to 80/20 is that in cases where the proportion of the epichlorohydrin rubber E is smaller than this range, a good semiconductivity for being a charging roller or developing roller cannot be imparted to the semiconductive roller.

Another reason is that in cases where the proportion of the diene rubber D as the basis of the oxide film is smaller than the range, an oxide film sufficiently capable of functioning as a protective film cannot be formed on the outer peripheral surface of the semiconductive roller, and contamination of the photoreceptor and accumulation of toner to the outer peripheral surface, etc. easily occur.

By contrast, by making the mass ratio (E/D) within such range, the semiconductive roller is imparted with good semiconductivity while having an oxide film sufficiently capable of functioning as a protective film formed on its outer peripheral surface, so that the contamination of the photoreceptor, etc. may be surely prevented from occurring.

(Epichlorohydrin Rubber)

Various polymers containing epichlorohydrin as a repeating unit and having ionic conductivity may be used as the epichlorohydrin rubber.

Examples of such epichlorohydrin rubber include one, two or more of the followings: an epichlorohydrin homopolymer, an epichlorohydrin-ethylene oxide binary copolymer (ECO), an epichlorohydrin-propylene oxide binary copolymer, an epichlorohydrin-allyl glycidyl ether binary copolymer, an epichlorohydrin-ethylene oxide-allyl glycidyl ether ternary copolymer (GECO), an epichlorohydrin-propylene oxide-allyl glycidyl ether ternary copolymer, and an epichlorohydrin-ethylene oxide-propylene oxide-allyl glycidyl ether quaternary copolymer, etc.

Among them, in order to impart excellent characteristics of a protective film to the oxide film formed on the outer peripheral surface of the semiconductive roller by ultraviolet irradiation, ECO and/or GECO is preferable.

An ethylene oxide content in both copolymers is preferably 30 mol % or more, and particularly preferably in the range of 50 mol % to 80 mol %.

The ethylene oxide serves to reduce a roller resistance of the entire semiconductive roller. However, when the ethylene oxide content is less than this range, since such effect cannot be sufficiently obtained, there is a concern that the roller resistance cannot be sufficiently reduced.

On the other hand, in cases where the ethylene oxide content exceeds the range, since crystallization o ethylene oxide occurs to hinder segmental motion of molecular chains, the roller resistance rather tends to increase. There are also concerns that that the semiconductive roller after crosslinking becomes too hard, and that viscosity of the semiconductive rubber composition before crosslinking is increased during heat melting.

The epichlorohydrin content in the ECO is the remaining amount excluding the ethylene oxide content. That is, the epichlorohydrin content is preferably not less than 20 mol % and not more than 70 mol %, particularly preferably not more than 50 mol %.

In addition, the allyl glycidyl ether content in the GECO is preferably in the range of 0.5 to 10 mol %, and particularly preferably in the range of 2 to 5 mol %.

The allyl glycidyl ether itself functions as a side chain to ensure a free volume, thus suppressing the crystallization of the ethylene oxide and serving to reduce the roller resistance value of the semiconductive roller. However, when the allyl glycidyl ether content is less than this range, since such effect cannot be obtained, there is a concern that the roller resistance value cannot be sufficiently reduced.

On the other hand, since the allyl glycidyl ether functions as a crosslinking point during crosslinking of GECO, in cases where the allyl glycidyl ether content exceeds the range, because the crosslinking density of GECO becomes overly high to hinder the segmental motion of molecular chains, the roller resistance rather tends to increase.

The epichlorohydrin content in GECO is the remaining amount excluding the ethylene oxide content and the allyl glycidyl ether content. That is to say, the epichlorohydrin content is preferably within the range of 10 mol % to 69.5 mol %, and particularly preferably within the range of 19.5 mol % to 60 mol %.

Moreover, as the GECO, in addition to copolymers in a narrow sense that they are prepared by copolymerizing the above three kinds of monomers, a modified product obtained by modifying the epichlorohydrin-ethylene oxide copolymer (ECO) with the allyl glycidyl ether is also known. Any GECO is applicable in the invention.

### (Diene Rubber)

Examples of the diene rubber include one, two or more of the followings: natural rubber, isoprene rubber (IR), butadiene rubber (BR), styrene-butadiene rubber (SBR), chloroprene rubber (CR), and acrylonitrile butadiene rubber (NBR), etc.

It is especially preferable to use NBR alone or use NBR and CR in combination.

Among them, NBR is especially excellent in the function as a diene rubber, namely, the function of being oxidized by ultraviolet irradiation to form an oxide film having excellent characteristics as a protective film on the outer peripheral surface of the semiconductive roller.

In addition, CR does not only have the function as the diene rubber. Since a large number of chlorine atoms are contained in the molecule, CR also functions to improve charging characteristics of the semiconductive roller of the invention especially when the latter is used as a charging roller.

Further, since both NBR and CR are polar rubbers, they also function to fine tune the roller resistance value of the semiconductive roller.

NBR may be any one of low-nitrile NBR having an acrylonitrile content of 24% or less, intermediate-nitrile NBR having an acrylonitrile content of 25 to 30%, moderate-nitrile NBR having an acrylonitrile content of 31 to 35%, high-nitrile NBR having an acrylonitrile content of 36 to 42%, and extremely high-nitrile NBR having an acrylonitrile content of 43% or more.

In addition, CR is synthesized by emulsion polymerization of chloroprene, and is classified into a sulfur-modified type and a non-sulfur-modified type depending on the kind of the molecular weight modifier used therefor.

Among them, the sulfur-modified CR is obtained by copolymerizing chloroprene and sulfur as the molecular weight modifier and plasticizing the resulting polymer with a thiuram disulfide or the like to adjust the viscosity thereof to a predetermined value.

In addition, the non-sulfur-modified CR is classified into, e.g., a mercaptan-modified type and a xanthogen-modified type, etc.

Among them, the mercaptan-modified CR is synthesized in the same manner as the sulfur-modified CR except that an alkyl mercaptan such as n-dodecyl mercaptan, t-dodecyl mercaptan or octyl mercaptan is used as the molecular weight modifier.

The xanthogen-modified CR is also synthesized in the same way as the sulfur-modified CR except that an alkyl xanthogen compound is used as the molecular weight modifier.

Besides, based on its crystallization speed, the CR is classified into a slow crystallization rate type, an intermediate crystallization rate type and a fast crystallization rate type.

Any type of CR may be used in the invention. However, among them, the non-sulfur-modified CR with a slow crystallization rate is preferable.

In addition, a copolymer of chloroprene and other copolymerization components may also be used as the CR. Examples of such copolymerization component include one, two or more of the following: 2,3-dichloro-1,3-butadiene, 1-chloro-1,3-butadiene, styrene, acrylonitrile, methacrylonitrile, isoprene, butadiene, acrylic acid, acrylic ester, methacrylic acid, and methacrylate ester, etc.

In cases where CR and NBR are used in combination as the diene rubber, in view of satisfactorily exhibiting respective functions, the two are preferably used in combination at a mass ratio of CR/NBR of from 15/85 to 50/50.

### <Crosslinking Component>

As described above, a triazine crosslinker and a sulfur-based crosslinking component are used in combination as the crosslinking component.

(Triazine Crosslinker)

As the triazine crosslinker, various triazine compounds having a triazine structure in the molecule and capable of functioning as a crosslinker for epichlorohydrin rubber may be used.

Examples of the triazine crosslinker include one, two or more of the followings: 2,4,6-trimercapto-s-triazine [Actor® TSH produced by Kawaguchi Chemical Industry Co., Ltd.], 2-anilino-4,6-dimercapto-s-triazine [Zisnet® AF by Sankyo Kasei Co., Ltd.], 2-dibutylamino-4,6-dimercapto-s-triazine [Zisnet® BD by Sankyo Kasei Co., Ltd.], etc.

The mixing proportion of the triazine crosslinker is preferably within the range of 0.5 to 3.0 mass parts based on a total amount of 100 mass parts of the base polymer.

If the mixing proportion of the triazine crosslinker is less than this range, permanent compression set of the semiconductive roller becomes larger, and during the aforementioned storage test, nip deformation may easily occur in the portion in contact with the photoreceptor. When the nip deformation occurs, there is a concern that in the area of the formed image corresponding to the nip deformed portion, an image defect of white stripes may be easily caused by a pitch of the photoreceptor.

On the other hand, in cases where the mixing proportion exceeds the range, the semiconductive roller becomes too hard and the follow-up property to the photoreceptor is reduced. As a result, there is a concern that shading is caused to the formed image by the pitch of the photoreceptor.

By contrast, by making the proportion of the triazine crosslinker in the above range, the semiconductive roller is provided with a moderate degree of permanent compression set and hardness, and a good image may be formed without any image defect caused by nip deformation or any shading caused by reduction in the follow-up property.

(Sulfur-Based Crosslinking Component)

As the sulfur-based crosslinking component, at least one crosslinker selected from the group consisting of sulfur and sulfur-containing crosslinkers, and a sulfur-containing accelerator are preferably used in combination.

Among them, as the sulfur-containing crosslinker, various organic compounds with sulfur in the molecule and capable of functioning as a crosslinker for diene rubber may be used. Examples of the same include 4,4′-dithiodimorpholine (R), etc.

However, as the crosslinker, sulfur is preferred.

In view of satisfactorily crosslinking the diene rubber and imparting the roller body with good characteristics as a rubber, namely softness and also a characteristic of reducing permanent compression set and hardly causing a fatigue, etc., the mixing proportion of sulfur is preferably in the range of 1 to 2 mass parts based on a total amount of 100 mass parts of the base polymer.

When an S-containing crosslinker is used as a crosslinker, the mixing proportion is preferably adjusted so that the proportion of the sulfur contained in the molecule based on a total amount of 100 mass parts of the base polymer falls within such range.

Examples of the sulfur-containing accelerator include one, two or more of the followings: a thiazole-based accelerator, a thiuram-based accelerator, a sulfenamide-based accelerator, and a dithiocarbamate-based accelerator, etc.

Among them, a combined use of a thiazole-based accelerator with a thiuram-based accelerator is preferable.

Examples of the thiazole-based accelerator include one, two or more of the followings: 2-mercaptobenzothiazole (M), di-2-benzothiazolyl disulfide (DM), 2-mercaptobenzothiazole zinc salt (MZ), 2-mercaptobenzothiazole cyclohexylamine salt (HM, M60-OT), 2-(N,N-diethylthiocarbamoylthio)benzothiazole (64), and 2-(4′-morpholinodithio)benzothiazole (DS, MDB), etc. Particularly, di-2-benzothiazolyl disulfide (DM) is preferred.

In addition, examples of the thiuram-based accelerator include one, two or more of the followings: tetramethylthiuram monosulfide (TS), tetramethylthiuram disulfide (TT, TMT), tetraethylthiuram disulfide (TET), tetrabuthylthiuram disulfide (TBT), tetrakis(2-ethylhexyl)thiuram disulfide (TOT-N), dipentamethylenethiuram tetrasulfide (TRA) and so on. Particularly, tetramethylthiuram monosulfide (TS) is preferred.

In combined uses of two kinds of such sulfur-containing accelerators, in view of sufficiently exhibiting the effect of accelerating the crosslinking of the diene rubber, the mixing proportion of the thiazole-based accelerator is preferably in the range of 1 to 2 mass parts based on a total amount of 100 mass parts of the base polymer. In addition, the mixing proportion of the thiuram-based accelerator is preferably in the range of 0.3 to 0.9 mass part based on a total amount of 100 mass parts of the base polymer.

<Ionic Salt>

Examples of the anion composing the ionic salt and having a fluoro group and a sulfonyl group in the molecule include one, two or more of the followings: fluoroalkylsulfonic acid ion, bis(fluoroalkylsulfonyl)imide ion, and tris(fluoroalkylsulfonyl)methide ion, etc.

Among them, examples of the fluoroalkylsulfonic acid ion include one, two or more of the followings: CF₃SO₃⁻, and C₄F₉SO₃⁻, etc.

In addition, examples of the bis(fluoroalkylsulfonyl)imide ion include one, two or more of the followings: (CF₃SO₂)₂N⁻, (C₂F₅SO₂)₂N⁻, (C₄F₉SO₂)(CF₃SO₂)N⁻, (FSO₂C₆F₄)(CF₃SO₂)N⁻, (C₈F₁₇SO₂)(CF₃SO₂)N⁻, (CF₃CH₂OSO₂)₂N⁻, (CF₃CF₂CH₂OSO₂)₂N⁻, (HCF₂CF₂CH₂OSO₂)₂N₋, and [(CF₃)₂CHOSO₂]₂N⁻, etc.

Further, examples of the tris(fluoroalkylsulfonyl)methide ion include one, two or more of the followings: (CF₃SO₂)₃C⁻, (CF₃CH₂OSO₂)₃C⁻, etc.

In addition, examples of the cation include one, two or more of the followings: an ion of an alkali metal such as sodium, lithium or potassium, an ion of a group 2 element such as beryllium, magnesium, calcium, strontium or barium, an ion of a transition element, a cation of an amphoteric element, quaternary ammonium ion, and imidazolium cation, etc.

As the ionic salt, lithium salts using lithium ion as the cation and potassium salts using potassium ion as the cation are particularly preferred.

Among them, in view of improving the ionic conductivity of the semiconductive rubber composition and reducing the roller resistance value of the semiconductive roller, (CF₃SO₂)₂NLi [lithium bis(trifluoromethanesulfonyl)imide] and/or (CF₃SO₂)₂NK [potassium bis(trifluoromethanesulfonyl)imide] is preferred.

The mixing proportion of the ionic salt is preferably within the range of 0.5 to 5 mass parts, and particularly preferably within the range of 0.8 to 4 mass parts, based on a total amount of 100 mass parts of the base polymer.

If the mixing proportion of the ion salt is less than this range, there is a concern that the effect of improving the ionic conductivity and reducing the roller resistance value of the semiconductive roller cannot be sufficiently obtained.

On the other hand, if the mixing proportion exceeds the range, not only no greater effect can be obtained, there is also a concern that excessive ion salt blooms on the outer peripheral surface of the semiconductive roller to hinder the formation of the oxide film by ultraviolet irradiation and to contaminate the photoreceptor.

### <Other Components>

Further, the semiconductive rubber composition may also include at least one additive selected from the group consisting of a crosslinking assistant, an acid acceptor, a processing aid, a filler, an antiaging agent, an antioxidant, an antiscorching agent, an ultraviolet absorber, a lubricant, a pigment, a flame retardant, a neutralizer, and an antifoaming agent.

Accordingly, when preparing the semiconductive rubber composition by mixing and kneading each of the above components, the workability and formability in forming the semiconductive rubber composition into a shape of the roller body may be improved, the mechanical strength, durability, etc. of the roller body obtained by crosslinking the base polymer after the forming may be improved, or characteristics of the roller body as a rubber, namely softness and also a characteristic of reducing permanent compression set and hardly causing a fatigue, etc. may be improved.

Examples of the crosslinking assistant include one, two or more of the followings: a metal oxide such as zinc oxide, etc., or a fatty acid such as stearic acid, oleic acid or cottonseed fatty acid, etc.

The mixing proportion of the crosslinking assistant is preferably within the range of 3 to 10 mass parts based on a total amount of 100 mass parts of the base polymer.

The acid acceptor serves to prevent the remaining chlorine-based gas from arising from the epichlorohydrin rubber E during the crosslinking of the semiconductive rubber composition, and to prevent contamination of the photoreceptor drum caused by the chlorine-based gas.

As the acid acceptor, hydrotalcites are preferable due to their excellence in dispersibility to rubber.

The mixing proportion of the acid acceptor is preferably within the range of 1 to 10 mass parts based on a total amount of 100 mass parts of the base polymer.

Examples of the processing aid include oil and a plasticizer, etc.

Examples of the filler include zinc oxide, silica, carbon black, clay, talc, calcium carbonate, magnesium carbonate, aluminum hydroxide, and alumina, etc. Among them, examples of the carbon black include insulating or weak conductive carbon black so as not to cause unevenness in electrical resistivity in the same roller body.

Examples of the antiscorching agent include N-cyclohexylthiophthalimide, phthalic anhydride, N-nitro sodiphenylamine, and 2,4-dipheny-4-methyl-1-pentene, etc.

Any well-known conventional compound may be used as the other component.

A semiconductive rubber composition containing the above components may be prepared in the same way as in the prior art. That is to say, the semiconductive rubber composition may be prepared by mixing an epichlorohydrin rubber and a diene rubber at a predetermined ratio and subjecting the mixture to mastication, followed by adding an additive other than the crosslinking component and kneading the resultant, and finally adding the crosslinking component and kneading the resultant.

The kneading may be performed by means of a kneader, a Banbury mixer, an extruder, etc.

### <Semiconductive Roller>

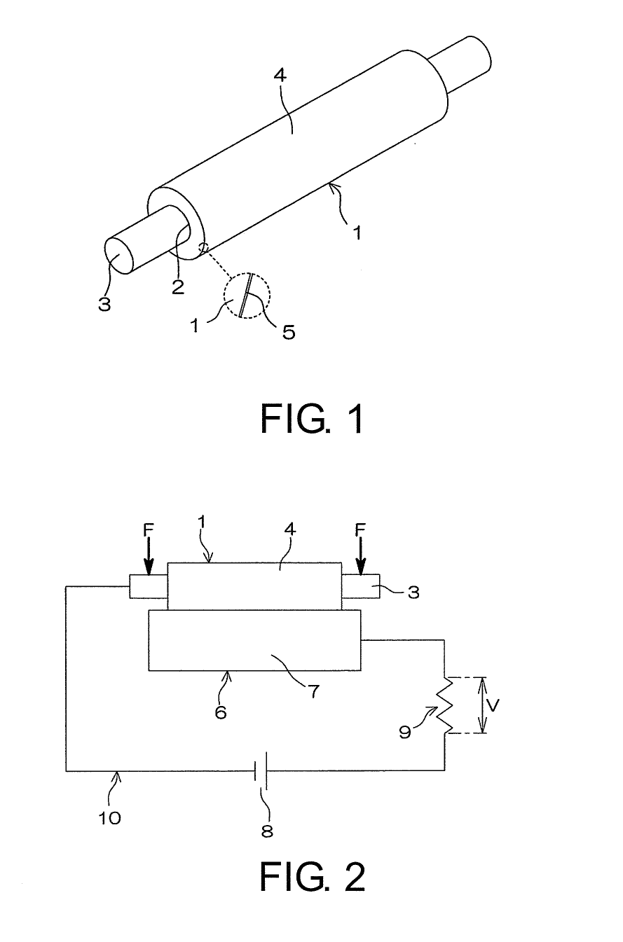

FIG. 1 is a perspective view of a semiconductive roller according to an embodiment of the invention.

Referring to FIG. 1, a semiconductive roller 1 of this example is formed into a cylindrical shape using the semiconductive rubber composition containing the above components. The semiconductive roller 1 has a shaft 3 fixedly inserted into a central through hole 2, and has an oxide film 5 formed on an outer peripheral surface 4 thereof by ultraviolet irradiation.

The shaft 3 is integrally formed of a metal such as aluminum, aluminum alloy, or stainless steel, etc. The semiconductive roller 1 and the shaft 3 are mechanically fixed while electrically connected together by, e.g., an adhesive having conductivity, so as to be rotated integrally.

Such semiconductive roller 1 is incorporated into an image forming apparatus utilizing xerography, e.g., a laser printer, and may be suitably used as a charging roller for uniformly charging the surface of the photoreceptor.

In cases of being used as a charging roller, to ensure a moderate nip thickness while attaining miniaturization and weight reduction of the charging roller, the thickness of the semiconductive roller 1 in the radial direction is preferably not less than 0.5 mm and particularly preferably not less than 1 mm, and preferably not more than 15 mm, more preferably not more than 10 mm and particularly preferably not more than 7 mm.

The semiconductive roller 1 is formed in the same manner as in the prior art using the semiconductive rubber composition containing the above components. That is, in a state that the semiconductive rubber composition is heat-melted during kneading using an extruder, the semiconductive rubber composition is extrusion-molded into a long cylindrical shape through a die corresponding to a cross-sectional shape of the roller 1, namely an annular shape, solidified by cooling, followed by inserting a temporary shaft for crosslinking into the through hole 2, and then subjecting the semiconductive rubber composition to crosslinking by heating in, e.g., a vulcanizer.

Next, the resultant is re-mounted to the shaft 3 having an outer peripheral surface coated with a conductive adhesive. When the adhesive is a thermosetting adhesive, the adhesive is cured by heating to electrically connect the semiconductive roller 1 to the shaft 3 and mechanically fix them.

Then, the outer peripheral surface 4 of the semiconductive roller 1 is polished to achieve a predetermined surface roughness, if necessary, and is then irradiated with ultraviolet rays to oxidize the diene rubber in the crosslinked product of the semiconductive rubber composition constituting the outer peripheral surface 4 and form the oxide film 5. Thus, the semiconductive roller 1 shown in FIG. 1 is fabricated.

Such semiconductive roller 1 is formed from the crosslinked product of the semiconductive rubber composition containing the above components. Hence, it not only has good semiconductivity for being a charging roller or a developing roller, but also is capable of surely avoid occurrence of tackiness and an image defect of white stripes associated with tackiness during implementation of the above storage test.

In addition, since the semiconductive roller 1 is provided with the oxide film 5 formed by oxidizing the outer peripheral surface 4 and having excellent characteristics of a protective film, it is also capable of surely preventing image defects due to contamination of the photoreceptor and accumulation of toner to the outer peripheral surface, etc. from occurring.

The semiconductive roller 1 may also be formed into a two-layer structure with an outer layer at the side of the outer peripheral surface 4 and an inner layer at the side of the shaft 3. In that case, at least the outer layer may be configured to have the constitution of the invention.

In addition, the semiconductive roller 1 may also have a porous structure. However, in view of surely preventing a nip deformation during the above storage test, a non-porous structure is preferable.

In an environment of normal temperature and humidity at 23° C. and a relative humidity of 55%, the semiconductive roller 1 of the invention is measured to have a roller resistance value of preferably 10⁴Ω or more and less than 10⁷Ω at an applied voltage of 200 V. The roller resistance value is a value measured in a state that the oxide film 5 is formed on the outer peripheral surface 4.

### <Measurement Method of Roller Resistance Value>

FIG. 2 illustrates a method of measuring the roller resistance value of the semiconductive roller 1.

Referring to FIG. 1 and FIG. 2, the roller resistance value in the invention is represented by a value measured by the following method.

Specifically, when the roller resistance value of the semiconductive roller 1 is to be measured, an aluminum drum 6 capable of rotating at a constant rotational speed is prepared, and the outer peripheral surface 4 of the semiconductive roller 1 having the oxide film 5 formed thereon is made to contact the outer peripheral surface 7 of such aluminum drum 6 from above.

In addition, a DC power supply 8 and resistor 9 are connected in series between the shaft 3 of the semiconductive roller 1 and the Al drum 6 to constitute a measurement circuit 10. The DC power supply 8 is connected to the shaft 3 by its (−) side and to the resistor 9 by its (+) side. The resistance value r of the resistor 9 is set to 100Ω.

Next, in a state that the semiconductive roller 1 is pressed against the Al drum 6 with a load F of 450 g applied at each of the two ends of the Al drum 6, while the Al drum 6 is rotated at a speed of 40 rpm and a voltage E of DC 200 V is applied between the two from the DC power supply 8, a detected voltage V that is applied to the resistor 9 is measured.

From the detected voltage V and applied voltage E (=200V), the roller resistance value R of the semiconductive roller 1 is basically obtained by a formula (1′):

R=r×E/(V−r) (1′)

However, since the item “−r” in the denominator in the formula (1′) may be regarded as very small, in the invention, the roller resistance value of the semiconductive roller 1 is represented by a value obtained by a formula (1):

R=r×E/V (1)

The conditions for the measurement are, as mentioned previously, a temperature of 23° C. and a relative humidity of 55%.

In addition, the semiconductive roller 1 may be adjusted to have arbitrary hardness and permanent compression set depending on its use, etc. In order to adjust such hardness and permanent compression set as well as the roller resistance value, etc., for example, the mass ratio (E/D) of the epichlorohydrin rubber to the diene rubber may be adjusted within the above range, and types and amounts of the triazine crosslinker and S-based crosslinking component as the crosslinking component may be adjusted.

The semiconductive roller of the invention may be used as, in addition to a charging roller, e.g., a developing roller, a transfer roller, a cleaning roller, etc. for an image forming apparatus utilizing xerography, such as a laser printer, an electrostatic photocopier, a plain paper facsimile apparatus, or a multifunction machine of these apparatuses, etc.

### EXAMPLES

Unless specified otherwise, the fabrication and tests of the semiconductive roller in the following Examples and Comparative Examples were made in an environment of normal temperature and humidity at 23° C. and a relative humidity of 55%.

### Example 1

60 mass parts of ECO [Epichlomer® D produced by Daiso Co., Ltd.; ethylene oxide content: 61 mol %] as the epichlorohydrin rubber and 40 mass parts of NBR [JSR N250 SL by JSR Corporation, low-nitrile NBR; acrylonitrile content: 20%] as the diene rubber were used as the base polymer and masticated using a 9 L kneader. 1 mass part of potassium bis(trifluoromethanesulfonyl)imide [K-TFSI, EF-N112 by Mitsubishi Materials Electronic Chemicals Co., Ltd.] as the ionic salt and the components shown in the following Table 1 were added thereto, and the resultant was further mixed and kneaded, thereby preparing a semiconductive rubber composition.

The epichlorohydrin rubber E and the diene rubber D had a mass ratio of E/D of 60/40.

TABLE 1

| Component | Mass part |
|---|---|
| Triazine crosslinker | 2.0 |
| Powdered sulfur | 1.5 |
| Accelerator DM | 1.5 |
| Accelerator TS | 0.5 |
| Two kinds of zinc oxides | 5 |
| Acid acceptor | 5 |

The components in Table 1 are described as follows.

Triazine crosslinker: 2,4,6-trimercapto-s-triazine [Actor® TSH produced by Kawaguchi Chemical Industry Co., Ltd.]

Powdered sulfur: crosslinker [produced by Tsurumi Chemical Industry Co., Ltd.]

Accelerator DM: di-2-benzothiazolyl disulfide [thiazole-based accelerator, Nocceler® DM produced by Ouchi Shinko Chemical Co., Ltd.]

Accelerator TS: tetramethylthiuram monosulfide [thiuram-based accelerator, Nocceler TS produced by Ouchi Shinko Chemical Co., Ltd.]

Two kinds of zinc oxides: crosslinking assistant [by Mitsui Mining & Smelting Co., Ltd.]

Acid acceptor: hydrotalcites [DHT-4A®-2 by Kyowa Chemical Industry Co., Ltd.]

The “mass part” in the table is based on 100 mass parts of the above base polymer.

Such semiconductive rubber composition was supplied to a φ60 extruder and extrusion-molded into a cylindrical shape having an outer diameter of φ11.0 mm and an inner diameter of φ5.0 mm. Then, a temporary shaft for crosslinking that has an outer diameter of φ3 mm was inserted therein. The resultant was crosslinked by heating in a vulcanizer at 160° C. for 30 min.

Next, the resultant was re-mounted to a shaft having an outer diameter of φ6 mm and having an outer peripheral surface coated with a conductive thermosetting adhesive (polyamide-based), and adhered thereto by heating in an oven at 150° C. for 60 min. After that, its two ends were cut off, and the outer peripheral surface was polished using a broad polisher until the outer diameter became φ9.0 mm.

After the polished outer peripheral surface was wiped with alcohol, a UV processor was set in which the UV light source has a distance of 50 mm from the outer peripheral surface, and the outer peripheral surface was rotated at 30 rpm while irradiated with ultraviolet rays for 15 min to form an oxide film, thereby fabricating the semiconductive roller.

### Examples 2 to 4

A semiconductive rubber composition was prepared in the same manner as in Example 1 except that the mixing amount of the triazine crosslinker was changed to 0.5 mass part (in Example 2), 1.5 mass parts (in Example 3) and 3.0 mass parts (in Example 4) based on 100 mass parts of the base polymer to fabricate a semiconductive roller.

In each Example, the epichlorohydrin rubber E and the diene rubber D had a mass ratio of E/D of 60/40.

### Example 5

A semiconductive rubber composition was prepared in the same manner as in Example 1 except that 15 mass parts of ECO [the above Epichlomer® D by Daiso Co., Ltd.] and 45 mass parts of GECO [Epion®-301 by Daiso Co., Ltd.; ethylene oxide content: 70 mol %; allyl glycidyl ether content: 4 mol %] were used in combination as the epichlorohydrin rubber, 40 mass parts of NBR [the above JSR N250 SL by JSR Corporation] and 10 mass parts of CR [Chloroprene® WRT by Showa Denko K.K.] were used in combination as the diene rubber, and the mixing amount of the potassium bis(trifluoromethanesulfonyl)imide [the above K-TFSI, EF-N112 from Mitsubishi Materials Electronic Chemicals Co., Ltd.] as the ionic salt was changed to 3.4 mass parts based on 100 mass parts of the base polymer to fabricate a semiconductive roller.

The epichlorohydrin rubber E and the diene rubber D had a mass ratio of E/D of 60/40.

### Example 6

A semiconductive rubber composition was prepared in the same manner as in Example 1 except that in place of ECO, 60 mass parts of GECO [the above Epion®-301 by Daiso Co., Ltd.] were used as the epichlorohydrin rubber, 40 mass parts of NBR [the above JSR N250 SL by JSR Corporation] and 10 mass parts of CR [Chloroprene® WRT by Showa Denko K.K.] were used in combination as the diene rubber, and the mixing amount of the potassium bis(trifluoromethanesulfonyl)imide [the above K-TFSI, EF-N112 by Mitsubishi Materials Electronic Chemicals Co., Ltd.] as the ionic salt was changed to 3.4 mass parts based on 100 mass parts of the base polymer to fabricate a semiconductive roller.

The epichlorohydrin rubber E and the diene rubber D had a mass ratio of E/D of 60/40.

### Example 7

A semiconductive rubber composition was prepared in the same way as Example 1, except that no ionic salt was mixed therein, to fabricate a semiconductive roller. The epichlorohydrin rubber E and the diene rubber D had a mass ratio of E/D of 60/40.

### Example 8

A semiconductive rubber composition was prepared in the same way as Example 1, except that 1.0 mass parts of lithium bis(trifluoromethanesulfonyl)imide [Li-TFSI, EF-N115 by Mitsubishi Materials Electronic Chemicals Co., Ltd.] were mixed therein as the ionic salt, to fabricate a semiconductive roller.

The epichlorohydrin rubber E and the diene rubber D had a mass ratio of E/D of 60/40.

### Example 9

The semiconductive rubber composition was prepared in the same way as Example 1, except that the mixing amount of ECO [the above Epichlomer® D by Daiso Co., Ltd.] as the epichlorohydrin rubber was changed to 50 mass parts and the mixing amount of NBR [the above JSR N250 SL by JSR Corporation] as the diene rubber was changed to 50 mass parts, to fabricate a semiconductive roller.

The epichlorohydrin rubber E and the diene rubber D had a mass ratio of E/D of 50/50.

### Example 10

The semiconductive rubber composition was prepared in the same way as Example 1, except that the mixing amount of ECO [the above Epichlomer® D by Daiso Co., Ltd.] as the epichlorohydrin rubber was changed to 80 mass parts and the mixing amount of NBR [the above JSR N250 SL by JSR Corporation] as the diene rubber was changed to 20 mass parts, to fabricate a semiconductive roller.

The epichlorohydrin rubber E and the diene rubber D had a mass ratio of E/D of 80/20.

### Comparative Example 1

The semiconductive rubber composition was prepared in the same way as Example 1, except that no triazine crosslinker was mixed in but 0.6 mass part of ethylenethiourea [Accel® 22-S by Kawaguchi Chemical Industry Company, Ltd.] as a thiourea-based crosslinker and 0.54 mass part of 1,3-di-o-tolylguanidine [Accelerator DT, Nocceler® DT by Ouchi Shinko Chemical Co., Ltd.] as a guanidine-based accelerator were mixed therein, to fabricate a semiconductive roller.

The epichlorohydrin rubber E and the diene rubber D had a mass ratio of E/D of 60/40.

This resultant was equivalent to a reproduction of the semiconductive roller of Patent Document 3.

### Comparative Example 2

The semiconductive rubber composition was prepared in the same manner as in Comparative Example 1, except that no UV ray was emitted to the outer peripheral surface of the semiconductive roller and no oxide film was formed on the outer peripheral surface, to fabricate a semiconductive roller.

The epichlorohydrin rubber E and the diene rubber D had a mass ratio of E/D of 60/40.

### Comparative Example 3

The semiconductive rubber composition was prepared in the same way as Example 1, except that no triazine crosslinker was mixed in, to fabricate a semiconductive roller.

The epichlorohydrin rubber E and the diene rubber D had a mass ratio of E/D of 60/40.

### Comparative Example 4

The semiconductive rubber composition was prepared in the same way as Example 1, except that the mixing amount of ECO [the above Epichlomer® D by Daiso Co., Ltd.] as the epichlorohydrin rubber was changed to 45 mass parts and the mixing amount of NBR [the above JSR N250 SL by JSR Corporation] as the diene rubber was changed to 55 mass parts, to fabricate the semiconductive roller.

The epichlorohydrin rubber E and the diene rubber D had a mass ratio of E/D of 45/55.

### Comparative Example 5

The semiconductive rubber composition was prepared in the same way as Example 1, except that the mixing amount of ECO [the above Epichlomer® D by Daiso Co., Ltd.] as the epichlorohydrin rubber was changed to 85 mass parts and the mixing amount of NBR [the above JSR N250 SL by JSR Corporation] as the diene rubber was changed to 15 mass parts, to fabricate a semiconductive roller.

The epichlorohydrin rubber E and the diene rubber D had a mass ratio of E/D of 85/15.

### <Measurement of Roller Resistance Value>

The roller resistance values of the semiconductive rollers fabricated in Examples and Comparative Examples were measured in the environment of normal temperature and humidity at 23° C. and a relative humidity of 55% using the above measurement method. In Tables 2 to 4, the roller resistance value is represented by log R value.

<Measurement of Hardness>

Type-A hardnesses of the semiconductive rollers fabricated in Examples and Comparative Examples were measured in accordance with the measurement method described in the Japanese Industrial Standards JIS K 6253-3: 2006 “Rubber, vulcanized or thermoplastic—Determination of hardness—Part 3: Durometer hardness.”

### <Real Machine Test>

A photoconductor unit [made by Lexmark International, Inc.] detachable to a laser printer main body is provided with a photoreceptor and a charging roller always in contact with the surface of the photoreceptor, wherein in place of the pure charging roller, the semiconductive rollers made in Examples and Comparative Examples were incorporated as the charging roller.

After being assembled, the photoconductor unit was immediately mounted to a color laser printer [C736n made by Lexmark International, Inc.], and instantly printed a halftone image and a solid image, which were evaluated as initial images.

One having any image defect founded was evaluated as “×”, while one having no image defect founded was evaluated as “∘”.

In addition, after implementation of paper supplying for 5 days at a rate of 2000 sheets per day, 5 sheets of halftone images and 5 sheets of solid images, respectively, were printed consecutively, and were evaluated as images after paper supplying.

One having any image defect founded during the consecutive printing was evaluated as “×”, while one having no image defect founded was evaluated as “∘”.

In addition, a separately prepared photoconductor unit was stood still for 30 days in an environment of high temperature and humidity at 50° C. and a relative humidity of 90% immediately after being assembled. Then, the photoconductor unit was mounted to the same color laser printer, and a storage test was performed to consecutively print 5 sheets of halftone images and 5 sheets of solid images, respectively.

The result was evaluated as “×” as long as one of the sheets was found to having an image defect of white stripes during the consecutive printing, while the result that none of the sheets was found to have any defect of white stripes during the consecutive printing was evaluated as “∘”.

The above results are shown in Table 2 to Table 4.

TABLE 2

| | | | Example 2 | Example 3 | Example 1 | Example 4 | Example 5 |
|---|---|---|---|---|---|---|---|
| Mass part | Epichlorohydrin | ECO | 60 | 60 | 60 | 60 | 15 |
| | rubber | GECO | — | — | — | — | 45 |
| | Diene rubber | NBR | 40 | 40 | 40 | 40 | 30 |
| | | CR | — | — | — | — | 10 |
| | Ionic salt | K-TFSI | 1 | 1 | 1 | 1 | 3.4 |
| | | Li-TFSI | — | — | — | — | — |
| | Triazine cross linker | | 0.5 | 1.5 | 2.0 | 3.0 | 2.0 |
| | Sulfur-based | Powdered sulfur | 1.5 | 1.5 | 1.5 | 1.5 | 1.5 |
| | crosslinking | Accelerator DM | 1.5 | 1.5 | 1.5 | 1.5 | 1.5 |
| | component | Accelerator TS | 0.5 | 0.5 | 0.5 | 0.5 | 0.5 |
| | Thiourea-based | Ethylenethiourea | — | — | — | — | — |
| | crosslinking | Accelerator DT | — | — | — | — | — |
| | component | | | | | | |
| Ultraviolet irradiation | | | Yes | Yes | Yes | Yes | Yes |
| Evaluation | Roller resistance value (logR) | | 5.6 | 5.7 | 5.8 | 5.9 | 4.8 |
| | Hardness | | 53 | 55 | 58 | 64 | 57 |
| | Real machine | Initial image | ∘ | ∘ | ∘ | ∘ | ∘ |
| | test | Image after paper | ∘ | ∘ | ∘ | ∘ | ∘ |
| | | supplying | | | | | |
| | | Storage test | ∘ | ∘ | ∘ | ∘ | ∘ |

TABLE 3

| | | | Example 6 | Example 7 | Example 8 | Example 9 | Example 10 |
|---|---|---|---|---|---|---|---|
| Mass part | Epichlorohydrin | ECO | — | 60 | 60 | 50 | 80 |
| | rubber | GECO | 60 | — | — | — | — |
| | Diene rubber | NBR | 30 | 40 | 40 | 50 | 20 |
| | | CR | 10 | — | — | — | — |
| | Ion salt | K-TFSI | 3.4 | — | — | 1 | 1 |
| | | Li-TFSI | — | — | 1 | — | — |
| | Triazine crosslinker | | 2.0 | 2.0 | 2.0 | 2.0 | 2.0 |
| | Sulfur-based | Powdered sulfur | 1.5 | 1.5 | 1.5 | 1.5 | 1.5 |
| | crosslinking | Accelerator DM | 1.5 | 1.5 | 1.5 | 1.5 | 1.5 |
| | component | Accelerator TS | 0.5 | 0.5 | 0.5 | 0.5 | 0.5 |
| | Thiourea-based | Ethylenethiourea | — | — | — | — | — |
| | crosslinking | Accelerator DT | — | — | — | — | — |
| | component | | | | | | |
| Ultraviolet irradiation | | | Yes | Yes | Yes | Yes | Yes |
| Evaluation | Roller resistance value (logR) | | 4.7 | 6.5 | 5.6 | 6.0 | 5.5 |
| | Hardness | | 56 | 58 | 55 | 54 | 56 |
| | Real machine | Initial image | ∘ | ∘ | ∘ | ∘ | ∘ |
| | test | Image after paper | ∘ | ∘ | ∘ | ∘ | ∘ |
| | | supplying | | | | | |
| | | Storage test | ∘ | ∘ | ∘ | ∘ | ∘ |

TABLE 4

| | | | Comparative | Comparative | Comparative | Comparative | Comparative |
|---|---|---|---|---|---|---|---|
| | | | Example 1 | Example 2 | Example 3 | Example 4 | Example 5 |
| Mass part | Epichlorohydrin | ECO | 60 | 60 | 60 | 45 | 85 |
| | rubber | GECO | — | — | — | — | — |
| | Diene rubber | NBR | 40 | 40 | 40 | 55 | 15 |
| | | CR | — | — | — | — | — |
| | Ion salt | K-TFSI | 1 | 1 | 1 | 1 | 1 |
| | | Li-TFSI | — | — | — | — | — |
| | Triazine crosslinker | | — | — | — | 2.0 | 2.0 |
| | Sulfur-based | Powdered sulfur | 1.5 | 1.5 | 1.5 | 1.5 | 1.5 |
| | crosslinking | Accelerator DM | 1.5 | 1.5 | 1.5 | 1.5 | 1.5 |
| | component | Accelerator TS | 0.5 | 0.5 | 0.5 | 0.5 | 0.5 |
| | Thiourea-based | Ethylenethiourea | 0.6 | 0.6 | — | — | — |
| | crosslinking | Accelerator DT | 0.54 | 0.54 | — | — | — |
| | component | | | | | | |
| Ultraviolet irradiation | | | Yes | No | Yes | Yes | Yes |
| Evaluation | Roller resistance value (logR) | | 5.8 | 5.6 | 5.3 | 6.2 | 5.4 |
| | Hardness | | 57 | 57 | 50 | 53 | 57 |
| | Real machine | Initial image | ∘ | ∘ | ∘ | ∘ | ∘ |
| | test | Image after paper | ∘ | x | ∘ | x | x |
| | | supplying | | | | | |
| | | Storage test | x | x | x | ∘ | ∘ |

From the results of all Examples and Comparative Example 1 among the comparative examples in Tables 2-4, the followings are known. In cases where conventional thiourea-based crosslinker and sulfur-based crosslinking component are used in combination as the crosslinking component, despite the formation of the oxide film with excellent characteristics as a protective film, an image defect of white stripes associated with tackiness occurs in the storage test.

In addition, from the result of Comparative Example 2, the followings are known. In such conventional system, in cases where no UV ray was emitted to the outer peripheral surface and no oxide film was formed, the defect of white stripes associated with tackiness occurs in the storage test, and an image defect of uneven shading associated with a contamination of the photoreceptor occurs in the image after paper supplying at the time of consecutive printing of 100 sheets.

Further, from the result of Comparative Example 3, the followings are known. In cases where only the sulfur-based crosslinking component is used as the crosslinking component, still, despite the formation of the oxide film having excellent characteristics of a protective film, the image defect of white stripes associated with tackiness occurs in the storage test.

By contrast, from the results of Examples 1 to 10, the followings are known. By using the triazine crosslinker and sulfur-based crosslinking component in combination as the crosslinking component, the image defect of white stripes associated with tackiness may be prevented from occurring in the storage test.

However, from the result of Comparative Example 4, the followings are known. Even in such combined use, in cases where the proportion of the epichlorohydrin rubber in the epichlorohydrin rubber E and the diene rubber D as the base polymer is less than the mass ratio (E/D) of 50/50, with an increase in the roller resistance value of the semiconductive roller, the image density is increased at the time of consecutive printing of 500 sheets after paper supplying to form an image defect.

In addition, from the result of Comparative Example 5, the followings are known. Even in such combined use, in cases where the proportion of the diene rubber as the basis of the oxide film is less than the mass ratio (E/D) of 80/20, since no oxide film having excellent characteristics of a protective film is formed, the image defect of uneven shading associated with contamination of the photoreceptor occurs in the image after paper supplying at the time of consecutive printing of 100 sheets.

By contrast, particularly from the results of Examples 9 and 10, the followings are known. By making the mass ratio (E/D) within the range of 50/50 to 80/20, the semiconductive roller is imparted with good semiconductivity while having the oxide film sufficiently capable of functioning as a protective film formed on its outer peripheral surface, so that the contamination of the photoreceptor, etc. may be surely prevented from occurring.

In addition, from the results of Examples 1 to 4, the followings are known. The mixing proportion of the triazine crosslinker is preferably with the range of 0.5 to 3.0 mass parts based on a total amount of 100 mass parts of the base polymer.

From the results of Examples 1, 5 and 6, the followings are known. As the epichlorohydrin rubber in the base polymer, not only ECO alone, but also GECO or a combination of ECO with GECO may be used; as the diene rubber, in addition to NBR, a combination of NBR with CR may be used.

Further, from the results of Examples 1, 7 and 8, the followings are known. It is preferred to mix an ionic salt into the semiconductive rubber composition, and potassium salt and lithium salt are preferably used as the ionic salt.

This invention has been disclosed above in the preferred embodiments, but is not limited to those. It is known to persons skilled in the art that some modifications and innovations may be made without departing from the spirit and scope of this invention. Hence, the scope of this invention should be defined by the following claims.

What is claimed is:

1. A semiconductive roller comprising a crosslinked product of a semiconductive rubber composition and having an oxide film formed on an outer peripheral surface thereof by ultraviolet irradiation,
wherein the semiconductive rubber composition comprises a base polymer and a crosslinking component for crosslinking the base polymer,
wherein the base polymer is a mixture of an epichlorohydrin rubber E and a diene rubber D having a mass ratio of E/D of 50/50 to 80/20, and
the crosslinking component comprises a triazine crosslinker and a sulfur-based crosslinking component.

2. The semiconductive roller of claim 1, wherein a mixing proportion of the triazine crosslinker is within a range of 0.5 to 3.0 mass parts based on a total amount of 100 mass parts of the base polymer.

3. The semiconductive roller of claim 1, wherein the sulfur-based crosslinking component comprises:
at least one crosslinker selected from the group consisting of sulfur and sulfur-containing crosslinkers, and
a sulfur-containing accelerator.

4. The semiconductive roller of claim 1, wherein the semiconductive rubber composition also comprises a salt of an anion and a cation as a conductive agent, the anion having a fluoro group and a sulfonyl group in a molecule thereof.

5. The semiconductive roller of claim 1, wherein the semiconductive rubber composition also comprises at least one additive selected from the group consisting of a crosslinking assistant, an acid acceptor, a processing aid, a filler, an antiaging agent, an antioxidant, an antiscorching agent, an ultraviolet absorbent, a lubricant, a pigment, a flame retardant, a neutralizer, and an antifoaming agent.

6. The semiconductive roller of claim 1, used as a charging roller in an image forming apparatus utilizing xerography, for charging a photoreceptor while in contact with the photoreceptor.
